(19) United States
(12) Patent Application Publication
(10) Pub. No.: US 2026/0166806 A1
(43) Pub. Date: Jun. 18, 2026

(54) POLYMERIC COMPOSITIONS FOR 3D PRINTING AND METHODS OF USE THEREOF

(71) Applicant: AQUAFIL S.p.A., Arco (TN) (IT)

(72) Inventors: Nicole SOLIGO, Trento (TN) (IT); Mauro BUCCELLA, Trento (TN) (IT); Anacleto DAL MORO, Semonzo di Borsa del Grappa (TV) (IT)

(21) Appl. No.: 19/126,399

(22) PCT Filed: Oct. 31, 2023
(86) PCT No.: PCT/IB2023/060952

§ 371 Date: May 1, 2025

(30) Foreign Application Priority Data
Nov. 3, 2022 (IT) 102022000022578

(51) Int. Cl. B29C 64/118; B29C 64/245; B33Y 50/02; B33Y 70/00; C08L 77/06

(52) U.S. Cl. CPC B29C 64/118; B29C 64/245; B33Y 50/02; B33Y 70/00; C08L 77/06; C08L 2205/02; C08L 2666/04

(57) ABSTRACT

A polymer composition, in a form of a filament or pellet, may include: (a) greater than or equal to 80% and less than or equal to 98% of at least one PA-6 polyamide; and (b) greater than or equal to 2% and less than or equal to 20% of at least one PA-6,9/6 copolymer. The percentages may be referred to a total weight of components (a) and (b). A method for manufacturing a three-dimensional (3D) product by an extrusion 3D printing process may include melting the polymer composition to obtain a melt polymer composition; and printing the melt polymer composition using an extrusion 3D printing system to form the 3D product.

### FIELD OF THE INVENTION

The present invention relates to a polymer composition for 3D printing and the method of use thereof. Particularly, the present invention relates to a polymer composition for 3D printing containing a mixture of polyamide polymers and the use thereof for manufacturing a three-dimensional object by an extrusion 3D printing system.

### BACKGROUND

Additive manufacturing (AM) is a technology by means of which three-dimensional objects are manufactured by depositing thin layers of a material on top of each other, starting from a digital representation of the object (e.g., a CAD/CAM file).

One of the most common AM techniques is extrusion 3D printing (referred to only as “3D printing” below). In extrusion 3D printing, a filament of solid thermoplastic material is supplied to a heated nozzle and thus extruded in the fluid (semi-liquid) form. The extruded material is deposited in the form of a thin layer (e.g., 0.03-0.2 mm) on a plane x-y of a construction substrate, along a predetermined path, where it is cooled and solidified. Then, by moving the construction substrate or the nozzle along an axis z, perpendicular to the plane x-y of the construction substrate, further material is extruded on the previously deposited material, to which it adheres by solidifying. Further layers of extruded material are then deposited on top of each other until completing the final object. This additive manufacturing technique is also known as Fused Deposition Modelling (FDM) or Fused Filament Fabrication (FFF).

Typically, in order to make products of relatively small size, in the FFF technique the thermoplastic material is supplied to a desktop printer in the form of a filament. However, the FDM technique can be also used for manufacturing objects on a higher scale, using printing devices in which the fluid thermoplastic material is deposited via an extruder to which the thermoplastic material is supplied in the form of grains.

FDM technology has different advantages, such as: a wide variety of usable thermoplastic materials, the good mechanical properties of the final object, the low manufacturing costs, the low cost of the equipment, flexibility in designing products, the possibility to make objects with complex geometry and easily customizable. Furthermore, FDM technology has a significantly reduced environmental impact with respect to the subtractive manufacturing (SM), where the final object or a part thereof is obtained from a block of rough material by operations of cutting, drilling, exfoliating, etc.

The above advantages, in addition to the agility and rapidity of manufacturing, causes the technology of additive manufacturing, particularly by FDM, to be applied in several industrial fields, such as for example: prototyping, aerospace, automotive, biomedical, packaging and jewellery.

Different thermoplastic materials usable for 3D printing having different mechanical properties and technical features are commercially available and known in the state of the art. The most used thermoplastic polymers in the form of a filament in the FDM technology for hobby applications are polylactic acid (PLA) and acrylonitrile-butadiene-styrene (ABS). Polyamides, known for their mechanical performance, are more commonly used for industrial applications. Particularly, the most common polyamides in the market are PA-11 and PA-12. Among polyamides, PA-6 (polycaprolactone) is considered a very promising polyamide due to its mechanical properties and to the high recycling potential. By chemical recycling techniques (e.g., hydrolytic depolymerization), indeed, the PA-6 can be transformed in its starting ε-caprolactam monomer having the same quality of the virgin monomer, thus being reusable for any type of applications.

PA-6, however, is a thermoplastic polymer which has different drawbacks in 3D printing processes. A first problem of this polyamide is associated to its high ability to absorb water in short time, reaching the saturation within minutes if exposed to favourable environmental humidity conditions. A second problem relates to the dimensional shrinkage of the polymer. The dimensional shrinkage after extrusion printing occurs due to the presence of residual stresses and the variation of the density of the polymer upon varying the temperature. In 3D printing, indeed, the temperature of the polymer deposited on the construction substrate decreases as the printing process proceeds. Furthermore, the printing time can continue for many hours if the product is big-sized. These intrinsic features of the PA6 cause a number of issues and limitations on the products manufactured by 3D printing processes. The most apparent drawbacks are:
1. “Warping”: it consists in the deformation of the printed product, which can lead to its detachment from the construction substrate during printing;
2. Delamination: a phenomenon occurring when the adhesion between the layers of polymer deposited is not optimal. The layers composing the product are detached resulting in structural failure of the product;
3. Formation of bubbles: the phenomenon occurs when the PA-6 supplied to the extruder is not enough dry (e.g., filament not stored under conditions of controlled humidity); water absorbed by the polymer evaporates at the high extrusion temperatures (1800-230° C.), leaving gaps in the printed product.

In order to solve these issues, modifying the composition of the PA-6 in different manners is known in the state of the art. For example, adding carbon fibers and glass fibers to the polyamide matrix of the filament to confer dimensional stability to the printed polymer is known. Fibers also improve the mechanical properties and the quality of the printed material.

Farina et al. “High-Performance Nylon-6 Sustainable Filaments for Additive Manufacturing”, (2019), Materials 12, no. 23: 3955 describe instead filaments for 3D printing based on PA-6 modified by adding ABS and TiO₂ in order to improve the printability of the material.

Jia et al. “Preparation of a new filament based on polyamide-6 for three-dimensional printing”, (2017), Polymer Engineering & Science, 57:1322-1328 address the problem of the dimensional shrinkage and the deformation by adding poly (ethylene 1-octene) grafted with maleic anhydride and possibly polystyrene to the PA-6 matrix to control the crystallization of the polymer.

In order to obtain printed products of higher quality than the use of the PA-6 as-is, using polyamide copolymers such as PA-6/6,6 copolymer, such as for example the filament Radilon® Adline marketed by Radici Group, is also known in the art.

US 2014/0141166 A1 describes thermoplastic materials for 3D printing formed by polyamide mixtures containing at least one semi-crystalline polyamide and one amorphous polyamide substantially mixable with the semi-crystalline polyamide, such as for example a PA-6/3T mixture. These mixtures have the advantage of allowing more effective treatments of annealing the printed products to reduce the accumulation of mechanical stresses and the resulting dimensional deformation therein.

A further product commercially available and suitable for 3D printing is the polyamide filament LUVOCOM 3F Filament PAHT (Levhoss). This filament, in the version without added fiber materials, has a higher printing quality than the PA-6 as-is.

However, the solutions described in the state of the art, while allowing to obtain 3D printed products of acceptable quality, have the drawback of complicating the polyamide recycling at the end of the life cycle of the printed object. Indeed, the presence of non-negligible amounts of additional fiber materials, such as glass and carbon fibers, and polymers other than PA-6 makes the chemical recycling process based on the depolymerization of PA-6 not very efficient, or even impossible.

### SUMMARY OF THE INVENTION

Considering the above state of the art, the Applicant has addressed the problem of providing a PA-6-based thermoplastic polymer composition for 3D printing which overcomes the drawbacks of the known art.

Particularly, an object of the present invention is to provide a PA-6-based polymer composition for 3D printing and a method of use thereof, which allow to manufacture printed products of comparable or higher quality than the polyamide-based polymer compositions of the known art.

A further object of the present invention is to provide a PA-6-based polymer composition for 3D printing and method of use thereof, from which printed products PA-6 can be easily retrieved by the known chemical recycling processes.

Now, it has been surprisingly found that the above and other objects, which will be better illustrated in the following description, can be achieved by a polymer composition comprising at least one PA-6 polyamide and at least one PA-6,9/6 copolymer. Indeed, it has been observed that adding modest amounts of the PA-6,9/6 copolymer to the PA-6 forming the polymer matrix at the base of the composition, allows to obtain a thermoplastic material which can be used in 3D printing processes for obtaining products with high printing quality.

Particularly, 3D printed products can be obtained by the polymer composition according to the present invention, also using different typologies of printers, characterized by uniformity of deposition of the melt material, good adhesion between the deposited layers, dimensional accuracy, possibility to print without supports and substantial absence of dimensional shrinkage and deformation (warping).

It has been also observed that, advantageously, cross-linking the polymer chains of the PA-6 and the PA-6,9/6 copolymer, obtainable by adding a cross-linking agent to the polymer composition, allows to effectively control the occurrence of deformation phenomena in the printed product.

The polymer composition according to the present invention is substantially formed by PA-6 polyamide, the components other than PA-6 (PA-6,9/6 copolymer and additives) being present indeed in relatively low amounts, for example lower than 20% by weight, preferably down to 5-10% by weight, of the weight of the polymer composition. The high PA-6 content makes the polymer composition and the products thereby manufactured easily recyclable by chemical recycling processes, such as the processes of hydrolytic depolymerization, which allow to retrieve the ε-caprolactam monomer with high performance and quality of the retrieved monomer.

Therefore, according to a first aspect, the present invention relates to a method for manufacturing a three-dimensional product by an extrusion 3D printing process comprising:
melting a polymer composition comprising:
(a) from 80% to 97% of at least one PA-6 polyamide,
(b) from 3% to 20% of at least one PA-6,9/6 copolymer,
said percentages being referred to the total weight of the components (a) and (b), to obtain a melt polymer composition;
printing the melt polymer composition by an extrusion 3D printing system to form said three-dimensional product.

In accordance with a second aspect, the present invention refers to a polymer composition, in the form of a filament or pellet, comprising:
(a) from 80% to 98% of at least one PA-6 polyamide;
(b) from 2% to 20% of at least one PA-6,9/6 copolymer,
said percentages being referred to the total weight of the components (a) and (b).

In accordance with a third aspect, the present invention refers to the use of the polymer composition in accordance with the second aspect for manufacturing a three-dimensional object by an extrusion 3D printing system.

### DETAILED DESCRIPTION OF THE INVENTION

As said, the polymer composition according to the present invention comprises at least: (a) one PA-6 polyamide and (b) at least one PA-6,9/6 copolymer. The PA-6 polyamide is present in the polymer composition in an amount within the range of 80% to 98% by weight with respect to the total weight of the components (a) and (b), preferably in the range of 85%-97% by weight, more preferably in the range of 90%-97% by weight.

The PA-6 polyamide can be prepared by polymerizing ε-caprolactam according to the processes well known to those skilled in the art. Advantageously, the PA-6 can include or be formed exclusively by ε-caprolactam deriving from recycling materials containing PA-6. ε-caprolactam, a raw material of the PA-6, can be virgin or recycled by chemical recycling. As well as the PA-6 can be virgin or come from a mechanical recycling.

Generally, any PA-6 polyamide of the type known in the art can be used for the purposes of the present invention. Preferably, the PA-6 has a melting temperature in the range of 215° C.-225° C. Preferably, the PA-6 has one or more of the following features:
value of RV (Relative Viscosity—ASTM D789-19) in the range of 2.2-3.3, preferably in the range of 2.4-2.7;
value of the colour coordinate b* (CIELAB) in the range of −4 to +5, preferably −2 to +2;
humidity equal to or lower than 0.5%, preferably equal to or lower than 0.1%.

The PA-6,9/6 copolymer is present in the polymer composition in an amount within the range of 2% to 20% by weight with respect to the total weight of the components (a) and (b), preferably in the range of 3%-15% by weight, more preferably in the range of 3%-10% by weight.

The PA-6,9/6 copolymer is a random copolymer having the formula (I) represented below comprising PA-6,9 repeating units and PA-6 repeating units.

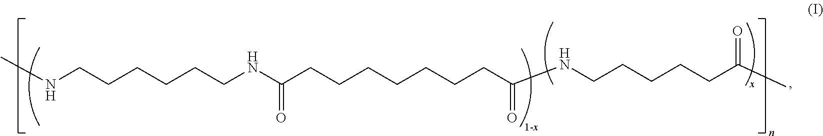

where:
   x is the number of PA-6 repeating units and 1-x the number of PA-6,9 repeating units, x being a number higher than 0 and lower than 1.
   n, being in connection with the length of the copolymer chains, is a number in the range of 40-75, preferably in the range of 50-65.

The PA-6,9/6 copolymer can be prepared by the synthesis processes known to those skilled in the art, for example from monomers such as hexamethylenediamine, ε-caprolactam and azelaic acid. A process for preparing the PA-6,9/6 copolymer which can be used for the purposes of the present invention is described in Bertolla, M. et al., “Comparison of the Properties of a Random Copolymer and a Molten Blend PA6/PA6.9”, Polymers 2022, 14, 4115 (https://doi.org/10.3390/polym14194115).

Preferably, the PA-6,9/6 copolymer contains PA-6,9 units and PA-6 units in a weight ratio PA-6,9:PA-6 in the range of 5:95-95:5, more preferably 10:90-90:10, even more preferably 15:85-85:15.

In an embodiment, the polymer composition according to the invention comprises:
(a) from 90% to 97% of at least one PA-6 polyamide;
(b) from 3% to 10% of at least one PA-6,9/6 copolymer;
wherein the weight ratio PA-6,9:PA-6 in the PA-6,9/6 copolymer is within the range of 5:95-95:5, preferably 10:90-90:10.

Preferably, the PA-6,9/6 copolymer has a melting temperature in the range of 215° C.-220° C.

Preferably, the PA-6,9/6 copolymer has one or more of the following features:
value of RV (relative Viscosity—ASTM D789-19) in the range of 2.4-3.3, preferably in the range of 2.6-3.0;
glass transition temperature (Tg) in the range of 25° C.-45° C., as a function of the composition of the monomers used in the step of manufacturing co-polyamide;
humidity equal to or lower than 0.5%, preferably equal to or lower than 0.1%.

In an embodiment, the polymer composition comprises at least one cross-linking agent for chemically binding the polymer chains of PA-6 and of the PA-6,9-6 co-polyamide to each other. For this purpose, cross-linking agents of the type known in the art can be used to cross-link the polymers obtained by condensation polymerization.

Particularly preferred cross-linking agents are (meth)acrylic or styrene-(meth)acrylic oligomers functionalized with epoxy groups. These compounds, also referred to as chain extenders, react with the end functional groups of the polymer chains of the polyamides of the polymer composition coupling them to each other. Preferably, the Epoxy Equivalent Weight (EEW) of the cross-linking agent is within the range of 180-2800 g/mol, more preferably 200-800 g/mol (EN ISO 3001). These cross-linking agents are described, for example, in WO 03/066704 and available on the market, for example the product Joncryl® ADR4400 by BASF.

Preferably, the at least one cross-linking agent (e.g., Joncryl® ADR4400) is present in the polymer composition in an amount within the range of 0.1%-5% by weight with respect to the total weight of the components (a) and (b), preferably in the range of 0.5%-1.5% by weight.

The polymer composition can further contain additives of the type generally used to prepare polymer compositions for use in 3D printing, such as colouring agents, compatibilizer, antioxidant, plasticizer, lubricant, flame retardant, impact modifier agents, and the like.

Although the use of filling materials (fillers), such as powders or fibers capable of improving the mechanical, thermal, and electrical conductivity properties, is not excluded, their presence in the polymer composition is not essential. In a preferred embodiment, the polymer composition does not contain added fillers, particularly the polymer composition is not added with glass fibers or carbon fibers.

In order to be used in 3D printing methods, the polymer composition can be formulated in the form of pellet or filament. Preferably, pellet and filaments are prepared by extrusion of a mixture of the components of the polymer composition, for example by a single-screw or twin-screw extruder.

The single ingredients of the polymer composition, i.e., PA-6, PA-6,9/6, and optional additives (e.g., cross-linking agent), can be supplied to the extruder after being pre-mixed or can be mixed to each other inside the extruder to form a homogeneous polymer composition.

Based on the typology of 3D printing process and device used, the polymer composition in the form of pellet can be used as-is to print a three-dimensional product.

In a preferred embodiment, the polymer composition can be extruded in the form of a filament having geometric shape (e.g., cylindrical or strip) and size suitable for use in a FDM printing process (e.g., 1-3 mm). The filament can be obtained by directly extruding the mixture of components of the polymer composition or converting by extrusion the pellets of the polymer composition.

In the case of extrusion 3D printing processes (FDM), the polymer composition described here is suitable to be used in 3D printers of the type known to those skilled in the art, even of very variable size.

Further features and advantages of the present invention will be apparent from the following exemplary embodiments of the invention, which are provided for merely illustrative purpose and should not be intended as limiting the scope of protection defined by the attached claims.

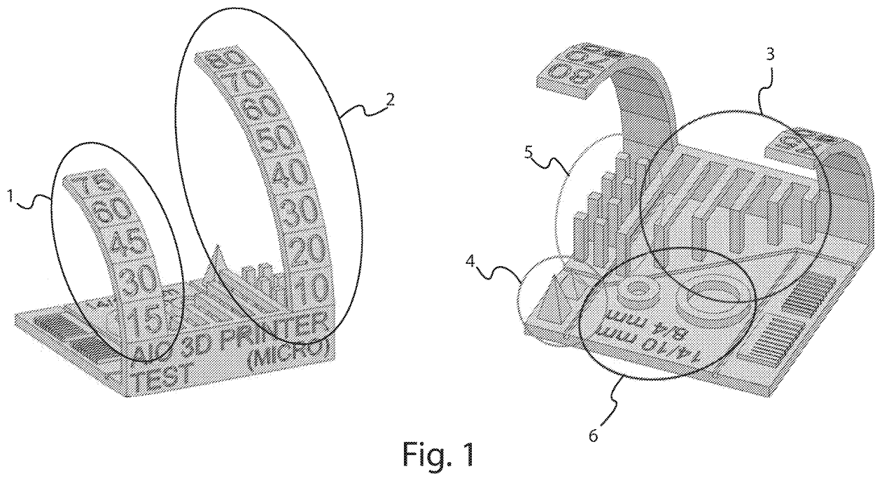

In the examples, reference will be made also to the attached FIG. 1, which reports a graphical representation of the printed three-dimensional product with the materials described in the examples.

### EXAMPLES

### 3D Printing Test

A set of thermoplastic polymer materials according to the invention and known in the state of the art were used in the form of a filament to print a three-dimensional product with a 3D printer Ultimaker 2+. The object to be printed is a so-called “All-in-One” product, whose digital file (CAD file) is available on the website www.thingiverse.com. The selected object to be printed is often used in the field of extrusion 3D printing to test the printing quality of a material. A graphical representation of the product is reported in FIG. 1. The product consists of multiple parts, each of which allows to evaluate a different printing property. For an objective evaluation of the printability (printing quality) of the tested materials, the quality of each of the following parts of the product was visually evaluated, whose numbering is referred to FIG. 1: small protrusion (1), large protrusion (2), bridge (3), cones (4), smears (5), dimensional accuracy (6), deformation (7).

The quality observed for parts 1-7 was evaluated using the scoring scale reported in Table 1.

TABLE 1

| | Small | Large | | | | Dimensional | | | |
|---|---|---|---|---|---|---|---|---|---|
| | protrusion | protrusion | Bridge | Cones | Smears | accuracy | | | |
| Score | (1) | (2) | (3) | (4) | (5) | (6) | | Deformation* | |
| 0 | 0° | 0° | 0/1 | Absence | Not | Not | | >5 | mm |
| | | | bridges | | constructed | constructed | | | |
| 1 | 15° | 20° | 2 | Melt | Many | >0.4 | mm | 4-5 | mm |
| | | | bridges | | | | | | |
| 2 | 30° | 40° | 3 | — | — | 0.3-0.4 | mm | 3-4 | mm |
| | | | bridges | | | | | | |
| 3 | 45° | 60° | 4 | Melt on | Few | 0.2-0.3 | mm | 2-3 | mm |
| | | | bridges | top | long side | | | | |
| 4 | 60° | 70° | 5 | — | Few | 0.1-0.2 | mm | 1-2 | mm |
| | | | bridges | | short side | | | | |
| 5 | 75° | 80° | 6/7 | No | No | <0.1 | mm | <1 | mm |
| | | | bridges | melting | | | | | |

*Deformation (warping): height of the corners of the product with respect to the plane x-y

The printability (printing quality) of the tested material was evaluated through the overall score deriving from the sum of the scores assigned to each of the printed parts 1-7.

### Example 1 (Comparative)

A PA-6 filament was obtained by extruding grains from the commercial product Econyl® EC027 manufactured by Aquafil SpA: it is a PA-6 polyamide obtained by a caprolactam monomer from chemical recycling (RV equal to 2.7, b* equal to −2.5, molecular weight of about 19500).

The extrusion was carried out in a single-screw extruder 3Devo under the condition reported in Table 2 (where T1-T4 are the temperatures along the extruders, from the inlet T1 to the extrusion die T4).

TABLE 2

| Parameter | Value | |
|---|---|---|
| T1 | 250° | C. |
| T2 | 240° | C. |
| T3 | 240° | C. |
| T4 | 240° | C. |
| Screw speed | 6 | rpm |
| Cooling | 50% | |
| Filament diameter | 2.85 | mm |

The evaluation of the printing quality of the product obtained with this filament is reported in Table 3.

TABLE 3
Example 1: filament in PA-6 (as-is)

| Small | Large | | | | Dimensional | | |
|---|---|---|---|---|---|---|---|
| protrusion | protrusion | Bridge | Cones | Smears | accuracy | | Total |
| (1) | (2) | (3) | (4) | (5) | (6) | Deformation | score |
| 2 | 1.5 | 3 | 3 | 4 | 3 | 3 | 19.5 |

The product in PA-6 (without any additive or copolymer) has different criticalities, particularly: the presence of gaps, the inconsistency of the product and the need to add supporting material to print in the gap and the apparent warping. Data reported for each part and the overall score are thus associable to a thermoplastic material not suitable for 3D printing.

### Example 2 (Comparative)

By comparison, a product was printed by using the commercial filament LUVOCOM 3F Filament PAHT (Levhoss) based on PA-6 (the exact chemical composition is unknown).

The evaluation of the printing quality of the product obtained with this filament is reported in Table 4.

TABLE 4
Example 2: commercial filament LUVOCOM 3F Filament PAHT (Levhoss)

| Small | Large | | | | Dimensional | | |
|---|---|---|---|---|---|---|---|
| protrusion | protrusion | Bridge | Cones | Smears | accuracy | | Total |
| (1) | (2) | (3) | (4) | (5) | (6) | Deformation | score |
| 4 | 2 | 5 | 3 | 3 | 2 | 5 | 24 |

The product has a printing quality overall higher than Example 1. From the score, some improvements related to the possibility to print without using supports, the absence of warping and a greater homogeneity of the product are highlighted. The printed product has however criticalities related to the low dimensional accuracy and the presence of smears. Furthermore, few months after printing, the product started to exhibit an apparent deformation, probably caused by a variation of the temperature of the product and/or by the humidity absorbed thereby over time. The filament is thus mainly adapted to print large-sized products, not requiring high detail accuracy.

### Example 3 (Comparative)

For comparison, a product was printed by using the commercial filament NYLFORCE3 based on PA-12 (the exact chemical composition is unknown).

The evaluation of the printing quality of the product obtained with this filament is reported in Table 5.

TABLE 5
Example 3: commercial filament PA-12

| Small | Large | | | | Dimensional | | |
|---|---|---|---|---|---|---|---|
| protrusion | protrusion | Bridge | Cones | Smears | accuracy | | Total |
| (1) | (2) | (3) | (4) | (5) | (6) | Deformation | score |
| 4 | 3 | 5 | 4 | 5 | 3 | 4 | 28 |

The PA-12-based filament is suitable for 3D printing, however, as known, it is not recyclable by depolymerization processes to retrieve the monomers it consists of.

### Example 4 (Invention)

A filament for 3D printing was prepared from pellets having the following composition:
94% by weight of PA-6
6% by weight of a PA-6,9/6 copolymer (copolymer composition: 80% PA-6,9 and 20% PA-6).

The commercial product Econyl® EC027 by Aquafil SpA of example 1 was used as the PA-6 polyamide.

The PA-6,9/6 copolymer, prepared as described in Bertolla, M. et al., Polymers 2022, 14, 4115, had the following features: RV equal to about 3.1, b* equal to −2.5, molecular weight of about 24000.

The extrusion of the filament was carried out as described in Example 1. The pellets of the polymer composition used to extrude the filament were prepared by extrusion, supplying PA-6 and PA-6,9/6 to a twin-screw extruder Twin Screw Extruder 20MM manufactured by LabTech Engineering under the conditions reported in Table 6 (where T1-T10 are the temperatures along the extruder, from the inlet T1 to the extrusion die T10).

TABLE 6

| Parameter | Value | |
|---|---|---|
| Motor power | 5.5 | kW |
| Rotational speed | 320 | RPM |
| Extruder mouth | 900° | C. |
| temperature (T1) | | |
| Temperatures (T2-T10) | 220° | C. |

The evaluation of the printing quality of the product obtained with this filament is reported in Table 7.

TABLE 7
Example 4: filament PA-6, 6% PA-6, 9/6 (80/20)

| Small | Large | | | | Dimensional | | |
|---|---|---|---|---|---|---|---|
| protrusion | protrusion | Bridge | Cones | Smears | accuracy | | Total |
| (1) | (2) | (3) | (4) | (5) | (6) | Deformation | score |
| 4 | 4 | 5 | 4 | 4 | 4 | 3 | 28 |

The filament of Example 4 has an improved printing quality with respect to the PA-6 as-is of Example 1 and comparable to the commercial product of Example 2.

### Example 5 (Invention)

By the same procedure of Example 4, a filament according to the invention was prepared from pellets having the following composition:
93.2% by weight of PA-6
0.8% by weight of cross-linking agent Joncryl ADR4400 by BASF (EEW equal to 485 g/mol)
6% by weight of a PA-6,9/6 copolymer (copolymer composition: 80% PA-6,9 and 20% PA-6).

The pellets of the polymer composition and the filament were prepared according to the procedure described in Example 4.

The evaluation of the printing quality of the product obtained with this filament is reported in Table 8.

TABLE 8
Example 5: filament PA-6, 6% PA-6, 9/6 (80/20), 0.8% cross-linking agent

| Small | Large | | | | Dimensional | | |
|---|---|---|---|---|---|---|---|
| protrusion | protrusion | Bridge | Cones | Smears | accuracy | | Total |
| (1) | (2) | (3) | (4) | (5) | (6) | Deformation | score |
| 4 | 3 | 5 | 4 | 5 | 3 | 5 | 29 |

The filament of Example 5 has a printing quality improved with respect to the PA-6 as-is of Example 1 and comparable to the commercial product of Example 2. With respect to Example 4, it can be noted that adding the chain extender caused an improvement in the “Deformation” test.

### Example 6 (Invention)

By the same procedure of Example 4, a filament according to the invention was prepared from pellets having the following composition:
96.2% by weight of PA-6
0.8% by weight of cross-linking agent Joncryl ADR4400
3% by weight of a PA-6,9/6 copolymer (copolymer composition: 80% PA-6,9 and 20% PA-6).

The evaluation of the printing quality of the product obtained with this filament is reported in Table 9.

TABLE 9
Example 6: filament PA-6, 3% PA-6, 9/6 (80/20), 0.8% cross-linking agent

| Small | Large | | | | Dimensional | | |
|---|---|---|---|---|---|---|---|
| protrusion | protrusion | Bridge | Cones | Smears | accuracy | | Total |
| (1) | (2) | (3) | (4) | (5) | (6) | Deformation | score |
| 3 | 2.5 | 3 | 3 | 4 | 4 | 4 | 23.5 |

### Example 7 (Invention)

By the same procedure of Example 4, a filament according to the invention was prepared from pellets having the following composition:
90.2% by weight of PA-6
0.8% by weight of cross-linking agent Joncryl ADR4400
9% by weight of a PA-6,9/6 copolymer (copolymer composition: 80% PA-6,9 and 20% PA-6).

The evaluation of the printing quality of the product obtained with this filament is reported in Table 10.

TABLE 10
Example 7: filament PA-6, 9% PA-6, 9/6 (80/20), 0.8% cross-linking agent

| Small | Large | | | | Dimensional | | |
|---|---|---|---|---|---|---|---|
| protrusion | protrusion | Bridge | Cones | Smears | accuracy | | Total |
| (1) | (2) | (3) | (4) | (5) | (6) | Deformation | score |
| 4 | 3 | 5 | 4 | 4 | 3 | 5 | 28 |

### Example 8 (Invention)

By the same procedure of Example 4, a filament according to the invention was prepared from pellets having the following composition:
93.2% by weight of PA-6
0.8% by weight of cross-linking agent Joncryl ADR4400
6% by weight of a PA-6,9/6 copolymer (copolymer composition: 20% PA-6,9 and 80% PA-6).

The evaluation of the printing quality of the product obtained with this filament is reported in Table 11.

TABLE 11
Example 8: filament PA-6, 6% PA-6, 9/6 (20/80), 0.8% cross-linking agent

| Small | Large | | | | Dimensional | | |
|---|---|---|---|---|---|---|---|
| protrusion | protrusion | Bridge | Cones | Smears | accuracy | | Total |
| (1) | (2) | (3) | (4) | (5) | (6) | Deformation | score |
| 4.5 | 3 | 5 | 4 | 3 | 4 | 4 | 27.5 |

### Example 9 (Invention)

By the same procedure of Example 4, a filament according to the invention was prepared from pellets having the following composition:
93.2% by weight of PA-6
0.8% by weight of cross-linking agent Joncryl ADR4400
6% by weight of a PA-6,9/6 copolymer (copolymer composition: 40% PA-6,9 and 60% PA-6).

The evaluation of the printing quality of the product obtained with this filament is reported in Table 12.

TABLE 12
Example 9: filament PA-6, 6% PA-6, 9/6 (40/60), 0.8% cross-linking agent

| Small | Large | | | | Dimensional | | |
|---|---|---|---|---|---|---|---|
| protrusion | protrusion | Bridge | Cones | Smears | accuracy | | Total |
| (1) | (2) | (3) | (4) | (5) | (6) | Deformation | score |
| 4 | 3 | 5 | 3.5 | 3 | 4 | 5 | 27.5 |

Examples 5-9 show the effectiveness of the polymer composition according to the invention as thermoplastic polymeric material for extrusion 3D printing. The printing quality of the thermoplastic material is comparable to or higher than the most used commercial products. By comparing Examples 8 and 9, it can be understood that the ratio between PA-6,9 and PA-6 in the copolymer, with the same amount of copolymer in the polymer composition, does not substantially affect the printability of the thermoplastic material. Using copolymers containing lower amounts of PA-6,9 polyamide promotes the chemical recycling of the ε-caprolactam monomer from the printed products at the end of life.

1. A method for manufacturing a three-dimensional (3D) product by an extrusion 3D printing process, the method comprising:
melting a polymer composition, comprising:
(a) greater than or equal to 80% and less than or equal to 98% of at least one PA-6 polyamide; and
(b) greater than or equal to 2% and less than or equal to 20% of at least one PA-6,9/6 copolymer;
wherein the percentages are referred to a total weight of components (a) and (b), to obtain a melt polymer composition, and
printing the melt polymer composition using an extrusion 3D printing system to form the 3D product.

2. The method of claim 1, wherein a weight ratio PA-6,9:PA-6 in the at least one PA-6,9/6 copolymer is greater than or equal to 5:95 and less than or equal to 95:5.

3. The method of claim 1, wherein the polymer composition further comprises:
(a) greater than or equal to 90% and less than or equal to 97% of the at least one PA-6 polyamide; and
(b) greater than or equal to 3% and less than or equal to 10% of the at least one PA-6,9/6 copolymer;
wherein a weight ratio PA-6,9:PA-6 in the at least one PA-6,9/6 copolymer is greater than or equal to 5:95 and less than or equal to 95:5.

4. The method of claim 1, wherein the polymer composition further comprises at least one cross-linking agent.

5. The method of claim 1, wherein the melt polymer composition is in a form of a filament or pellet.

6. The method of claim 1, wherein the printing of the melt polymer composition is carried out according to a fused deposition modelling (FDM) technique.

7. A polymer composition, in a form of a filament or pellet, the polymer composition comprising:
(a) greater than or equal to 80% and less than or equal to 98% of at least one PA-6 polyamide; and
(b) greater than or equal to 2% and less than or equal to 20% of at least one PA-6,9/6 copolymer;
wherein the percentages are referred to a total weight of components (a) and (b).

8. The polymer composition of claim 7, wherein a weight ratio PA-6,9:PA-6 in the at least one PA-6,9/6 copolymer is greater than or equal to 5:95 and less than or equal to 95:5.

9. The polymer composition of claim 7, further comprising:
(a) greater than or equal to 90% and less than or equal to 97% of the at least one PA-6 polyamide; and
(b) greater than or equal to 3% and less than or equal to 10% of the at least one PA-6,9/6 copolymer;
wherein the percentages are referred to the total weight of the components (a) and (b), and
wherein a weight ratio PA-6,9:PA-6 in the at least one PA-6,9/6 copolymer is greater than or equal to 5:95 and less than or equal to 95:5.

10. The polymer composition of claim 7, further comprising:
at least one cross-linking agent.

11. (canceled)

12. The method of claim 1, wherein a weight ratio PA-6,9:PA-6 in the at least one PA-6,9/6 copolymer is greater than or equal to 10:90 and less than or equal to 90:10.

13. The method of claim 1, wherein a weight ratio PA-6,9:PA-6 in the at least one PA-6,9/6 copolymer is greater than or equal to 15:85 and less than or equal to 85:15.

14. The method of claim 1, wherein the polymer composition further comprises:
(a) greater than or equal to 90% and less than or equal to 97% of the at least one PA-6 polyamide; and
(b) greater than or equal to 3% and less than or equal to 10% of the at least one PA-6,9/6 copolymer;
wherein a weight ratio PA-6,9:PA-6 in the at least one PA-6,9/6 copolymer is greater than or equal to 10:90 and less than or equal to 90:10.

15. The method of claim 1, wherein the polymer composition further comprises at least one cross-linking agent in an amount greater than or equal to 0.1% and less than or equal to 5% by weight with respect to the total weight of the components (a) and (b).

16. The method of claim 1, wherein the polymer composition further comprises at least one cross-linking agent in an amount greater than or equal to 0.5% and less than or equal to 1.5% by weight with respect to the total weight of the components (a) and (b).

17. The polymer composition of claim 7, wherein a weight ratio PA-6,9:PA-6 in the at least one PA-6,9/6 copolymer is greater than or equal to 10:90 and less than or equal to 90:10.

18. The polymer composition of claim 7, wherein a weight ratio PA-6,9:PA-6 in the at least one PA-6,9/6 copolymer is greater than or equal to 15:85 and less than or equal to 85:15.

19. The polymer composition of claim 7, further comprising:
(a) greater than or equal to 90% and less than or equal to 97% of the at least one PA-6 polyamide; and
(b) greater than or equal to 3% and less than or equal to 10% of the at least one PA-6,9/6 copolymer;
wherein the percentages are referred to the total weight of the components (a) and (b), and
wherein a weight ratio PA-6,9:PA-6 in the at least one PA-6,9/6 copolymer is greater than or equal to 10:90 and less than or equal to 90:10.

20. The polymer composition of claim 7, further comprising:
at least one cross-linking agent in an amount greater than or equal to 0.1% and less than or equal to 5% by weight with respect to the total weight of the components (a) and (b).

21. The polymer composition of claim 7, further comprising:
at least one cross-linking agent in an amount greater than or equal to 0.5% and less than or equal to 1.5% by weight with respect to the total weight of the components (a) and (b).
